(19) United States
(12) Patent Application Publication
(10) Pub. No.: US 2026/0092835 A1
(43) Pub. Date: Apr. 2, 2026

(54) DYNAMIC MONITORING DEVICE FOR FATIGUE CRACKS OF AIRCRAFT ENGINE ON HIGHTEMPERATURE TEST RIG

(71) Applicant: Eddysun (Xiamen) Electronics Co., Ltd., Xiamen (CN)

(72) Inventors: Junming Lin, Xiamen (CN); Zesen Lin, Xiamen (CN)

(21) Appl. No.: 19/345,046

(22) Filed: Sep. 30, 2025

(30) Foreign Application Priority Data
Sep. 30, 2024 (CN) 202411387267.0

(51) Int. Cl. G01M 15/14; G01N 27/90

(52) U.S. Cl. CPC G01M 15/14; G01N 27/9006

(57) ABSTRACT

A dynamic monitoring device for fatigue cracks of an aircraft engine on a high-temperature test rig includes a profiled housing, an eddy current testing sensor, a signal processing module, a wireless communication module, and a miniature centrifugal cooler which are encapsulated inside the profiled housing. A detection end face of the profiled housing includes a plurality of miniature air film holes, and the plurality of miniature air film holes cooperate with the miniature centrifugal cooler to form a cooling air film. An inner side wall and an outer side wall of the profiled housing respectively includes a built-in water cooling pipe and an external wind-guide channel to enhance a cooling effect. The eddy current testing sensor includes a ferrite core and insulated wires wound around the ferrite core, which can effectively detect tiny fatigue cracks.

### RELATED APPLICATIONS

This application claims priority to Chinese patent application number 202411387267.0, filed on September 30, 2024. Chinese patent application number 202411387267.0 is incorporated herein by reference.

### FIELD OF THE DISCLOSURE

The present disclosure relates to the field of eddy current dynamic monitoring technology and in particular to a dynamic monitoring device for fatigue cracks of an aircraft engine on a high-temperature test rig.

### BACKGROUND OF THE DISCLOSURE

Aircraft engines are known as the "crown jewel of modern industry," highlighting their esteemed position in the industrial field. The operating environment for the aircraft engines is extremely harsh, requiring stable operation under conditions of high temperature, high pressure, and high rotational speed for extended periods. Therefore, before a new model of engine takes to the skies, it must undergo simulated testing on a test rig. This includes examining parameters such as the expansion rate, location, and variation of fatigue cracks under different rotational loads, temperatures, and pressures when fatigue cracks occur in the engine test spindle. These parameters are of critical concern to engineering professionals. In the existing techniques, Chinese Patent Application No. 202411287234.9 discloses a monitoring method for a fatigue crack propagation state of a spindle of an aircraft engine on a high-speed test rig. This method utilizes a monitoring device to achieve dynamic monitoring of fatigue crack propagation trends during high-speed operation of the aircraft engine by creating asynchronous relative motion between the monitoring device and the spindle.

However, in practical test applications, during the high-speed operation of the aircraft engine, temperatures can reach as high as 600°C. The eddy current sensor described in the aforementioned patent, which comprises coils, struggles to meet the requirements for temperature resistance, including temperature drift, sensitivity, and reliability, all at the same time. Therefore, how to further enhance the temperature resistance of eddy current sensors remains an urgent problem to be solved.

### BRIEF SUMMARY OF THE DISCLOSURE

The technical problem to be solved by the present disclosure is to provide a dynamic monitoring device for fatigue cracks of an aircraft engine on a high-temperature test rig. The present disclosure is realized as follow.

A dynamic monitoring device for fatigue cracks of an aircraft engine on a high-temperature test rig is configured to use a testing method of a monitoring device and a test spindle forming asynchronous relative motion under simulated high-speed rotation, and perform dynamic monitoring at a monitoring point predefined on a central bore of the test spindle. The monitoring device comprises a profiled housing, as well as an eddy current testing sensor, a signal processing module, a wireless communication module, and a miniature centrifugal cooler that are encapsulated inside the profiled housing.

A detection end face of the profiled housing comprises a plurality of miniature air film holes. At least one of an external side wall opposite to the detection end face or two external side walls adjacent to the detection end face of the profiled housing each comprises a wind-guide channel, and an air inlet and an air outlet of the wind-guide channel form a symmetrical double-horn-shaped structure. An inner wall of the wind-guide channel is coated with a heat-dissipating coating.

The eddy current testing sensor is installed at a position inside of the profiled housing adjacent to the detection end face. The eddy current testing sensor comprises a ferrite core and insulated wires, and the insulated wires are wound around an outside of the ferrite core.

The signal processing module and the wireless communication module are encapsulated on a rear end of the eddy current testing sensor and are electrically connected to the eddy current testing sensor.

The miniature centrifugal cooler comprises a coolant storage chamber and a plurality of airflow conduits connected to the coolant storage chamber, and first ends of the plurality of airflow conduits are respectively connected to the plurality of miniature air film holes corresponding to the plurality of airflow conduits. A junction between the plurality of airflow conduits and the coolant storage chamber is disposed with a centrifugal opening-and-closing valve that is automatically controlled by a centrifugal force.

Furthermore, the centrifugal opening-and-closing valve comprises a circular valve body, a rotating valve flap, and a sealing ring. The rotating valve flap is installed on a middle of the circular valve body, and the sealing ring is embedded between the circular valve body and the junction. When the monitoring device rotates at high speed, the rotating valve flap moves due to the centrifugal force to be opened, and the coolant storage chamber is in communication with the plurality of airflow conduits.

Furthermore, the at least one of the external side wall opposite to the detection end face or the two external side walls adjacent to the detection end face of the profiled housing each comprises a built-in water cooling pipe inside the profiled housing, and the built-in water cooling pipe is sealed and filled with coolant.

Furthermore, the plurality of miniature air film holes are circular or elliptical.

Furthermore, the plurality of airflow conduits are straight or curved.

Compared with the existing techniques, the technical solution has the following advantages.

The present disclosure provides the monitoring device with thermal insulation and heat dissipation effects, which comprises the profiled housing, the high-frequency magnetic-concentration eddy current testing sensor, the signal processing module, the wireless communication module, and the miniature centrifugal cooler, which are encapsulated within the profiled housing. By utilizing the centrifugal force generated during the high-speed rotation of the monitoring device, the opening and closing of the plurality of airflow conduits of the miniature centrifugal cooler are controlled. This allows the supply of coolant to be delivered to the plurality of miniature air film holes on the surface of the profiled housing, thereby forming an air film with thermal insulation effects on the detection end face of the profiled housing. The overall structure is reliable, ensuring the effective operation of the eddy current testing sensor. Through the wind-guide channel on an outer side of the profiled housing, during the high-speed rotation of the monitoring device, the specially designed wind-guide channel structure induces surrounding airflow to rapidly flow through the channel, enhancing heat dissipation. Simultaneously, the resulting circulating air layer also provides an additional thermal insulation effect.

### BRIEF DESCRIPTION OF THE DRAWINGS

In order to more clearly illustrate the embodiments of the present disclosure, the technical solutions in the existing techniques, or the drawings required for use in the description of the existing techniques, a brief introduction is given. Obviously, for those of ordinary skill in the art, other drawings can be obtained based on these drawings without paying any creative work.

FIG. 1 is a schematic diagram of a relative position between a monitoring device and a test spindle.

FIG. 2 is a connection relationship diagram of an eddy current testing sensor, a signal processing module, and a wireless communication module.

FIG. 3 is simplified schematic of an internal encapsulated structure of the monitoring device.

FIG. 4 is a simplified schematic of a detection end surface of a profiled housing.

FIG. 5 is a simplified schematic of a ferrite core and insulated wires.

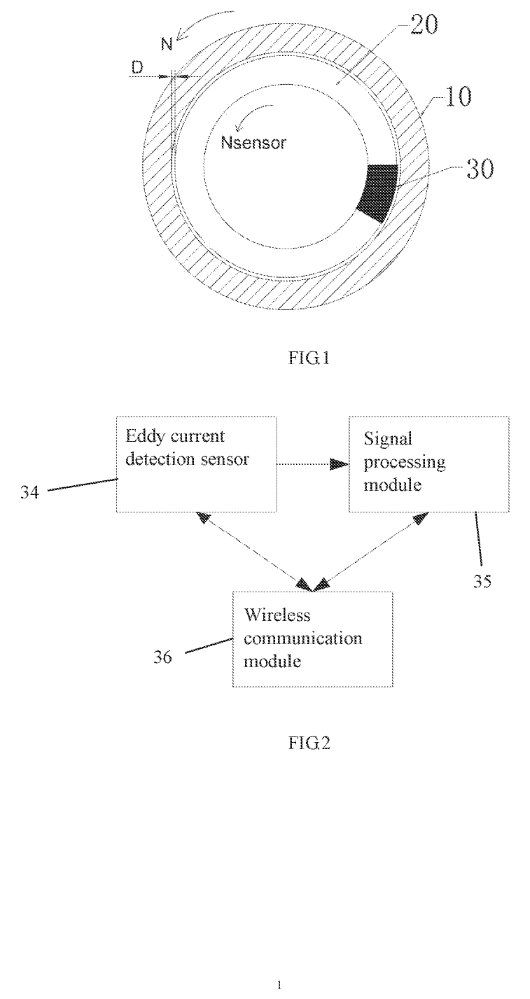

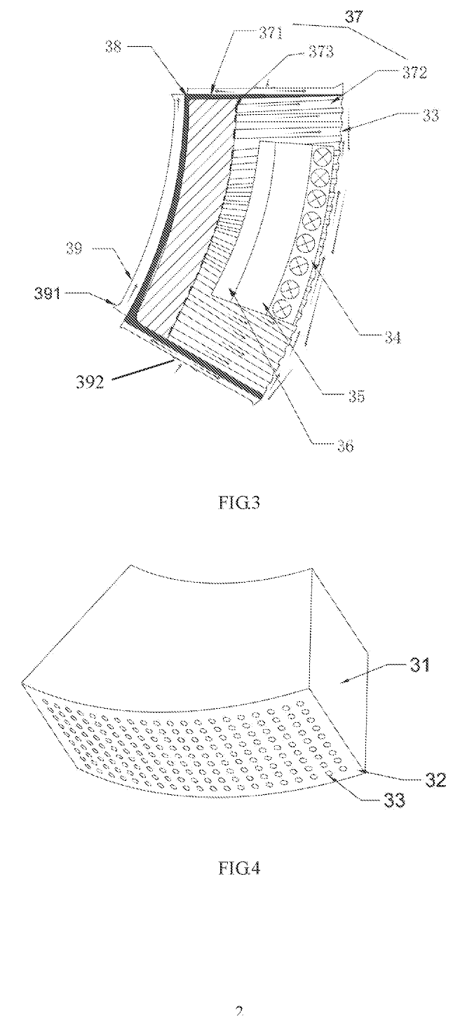

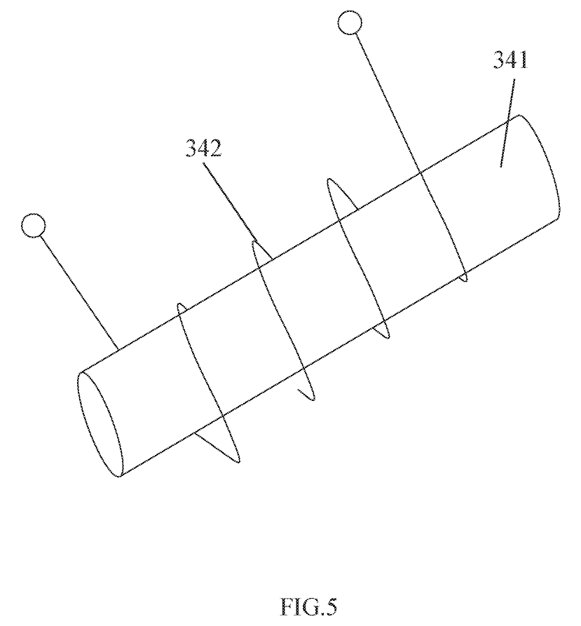

In the figures:

10-Test spindle; 20-Guiding rail; 30-Monitoring device; 31-Profiled housing; 32-Detection end surface; 33-Miniature air film hole; 34-Eddy current testing sensor; 341-Ferrite core; 342-Insulated wires; 35-Signal processing module; 36-Wireless communication module; 37-Miniature centrifugal cooler; 371-Coolant storage chamber; 372-Airflow conduit; 373-centrifugal opening-and-closing valve; 38-Built-in water cooling pipe; 39-wind-guide channel; and 391-symmetrical double-horn-shaped structure.

### DETAILED DESCRIPTION OF THE EMBODIMENTS

The following will clearly and completely describe the technical solutions in the embodiments of the present disclosure with reference to the accompanying drawings. Obviously, the described embodiments are only a portion of the embodiments of the present disclosure, and not all of the embodiments. Based on the embodiments of the present disclosure, all other embodiments obtained by those of ordinary skill in the art without creative work fall within the protection scope of the present disclosure. Therefore, the following detailed descriptions of the embodiments of the present disclosure provided in the accompanying drawings are not intended to limit the scope of the present disclosure as claimed, but merely show selected embodiments of the present disclosure.

The present disclosure discloses a dynamic monitoring device for fatigue cracks on of an aircraft engine on a high-temperature test rig, used to form asynchronous relative motion with a test spindle 10 that simulates high-speed rotation on the high-temperature test rig and perform dynamic monitoring at a monitoring point predefined on a central bore of the test spindle 10 (i.e., the test spindle 10 is rotated in a direction N, and the monitoring device 30 is rotated in a direction Nsensor). The monitoring point is predefined on the central bore of the test spindle 10. A guiding rail 20 is coaxially installed along a circumferential direction of the central bore, and the guiding rail 20 maintains a fixed distance D relative to an inner surface of the central bore of the test spindle 10. The monitoring device 30 of the present disclosure is slidably installed on the guiding rail 20, and a detection surface of the monitoring device 30 faces the inner surface of the central bore of the test spindle 10.

In this embodiment, the monitoring device 30 comprises a profiled housing 31, an eddy current testing sensor 34, a signal processing module 35, a wireless communication module 36, and a miniature centrifugal cooler 37. The eddy current testing sensor 34, the signal processing module 35, the wireless communication module 36, and the miniature centrifugal cooler 37 are encapsulated inside the profiled housing 31. The eddy current testing sensor 34 is installed at a position inside of the profiled housing 31 adjacent to a detection end face 32 (i.e., the detection surface). The signal processing module 35 and the wireless communication module 36 are encapsulated on a rear end of the eddy current testing sensor 34 and are electrically connected to the eddy current testing sensor 34. The miniature centrifugal cooler 37 can be installed at any position inside the profiled housing 31.

The detection end face 32 of the profiled housing 31 comprises a plurality of miniature air film holes 33. The miniature centrifugal cooler 37 comprises a coolant storage chamber 371 and a plurality of airflow conduits 372 connected to the coolant storage chamber 371. First ends of the plurality of airflow conduits 372 are respectively connected to the plurality of miniature air film holes 33 corresponding to the plurality of airflow conduits. A junction between the plurality of airflow conduits 372 and the coolant storage chamber 371 is disposed with a centrifugal opening-and-closing valve 373 that is automatically controlled by a centrifugal force.

In this embodiment, the centrifugal opening-and-closing valve 373 comprises a circular valve body, a rotating valve flap, and a sealing ring. The rotating valve flap is installed on a middle of the circular valve body, and the sealing ring is embedded between the circular valve body and the junction. When the monitoring device 30 rotates at a high speed, the rotating valve flap moves due to the centrifugal force to be opened, and the coolant storage chamber 371 is in communication with the plurality of airflow conduits 372.

During detection, as the monitoring device 30 performs asynchronous relative rotation with the test spindle 10, the centrifugal opening-and-closing valve 373 of the miniature centrifugal cooler 37 is opened due to the centrifugal force to enable coolant to be pushed into the plurality of airflow conduits 372. The coolant flows within the plurality of airflow conduits 372, and the coolant is rapidly expelled to an outside of the profiled housing 31 due to the centrifugal force, forming a cooling air film that insulates the sensor (i.e., the eddy current testing sensor 34) and cools an external environment.

In this embodiment, the eddy current testing sensor 34 comprises a ferrite core 341 and insulated wires 342. The insulated wires 342 are wound around an outside of the ferrite core 341. The insulated wires are highly conductive, have low temperature drift, and are stable fine insulated wires. The ferrite core 341 has a property of magnetic permeability that does not drift with temperature. The combination of the two components (i.e., the ferrite core 341 and the insulated wires 342) creates a high-frequency magnetic-concentrating eddy current testing sensor capable of effectively detecting small fatigue defects on the test spindle 10.

Furthermore, at least one of an external side wall opposite to the detection end face 32 or two external side walls adjacent to the detection end face 32 of the profiled housing 31 each comprises a wind-guide channel 39. In this embodiment, an air inlet and an air outlet of the wind-guide channel 39 form a symmetrical double-horn-shaped structure 391. In this embodiment, a middle of the wind-guide channel 39 on the two external side walls adjacent to the detection end face 32 comprises an air inlet-and-outlet port 392, forming multi-directional airflow.

Additionally, an inner wall of the wind-guide channel 39 is coated with a heat-dissipating coating. The wind-guide channel 39 with the symmetrical double-horn-shaped structure 391 enables rapid air intake or exhaust from any direction, removing heat from a surface of the monitoring device 30 and enhancing a cooling effect. Simultaneously, a resulting circulating air layer also provides insulation. In this embodiment, the heat-dissipating coating uses a porous sweating cooling material. The porous sweating cooling material absorbs moisture or other coolants, and as the monitoring device 30 rotates, the temperature rises, causing the water or coolant within the porous sweating cooling material to evaporate and absorb a large amount of heat. This heat is exchanged with the airflow through the wind-guide channel 39, improving the cooling effect.

Additionally, the at least one of the opposite external side wall opposite to the detection end face 32 or the two external side walls adjacent to the detection end face 32 of the profiled housing 31 each comprises a built-in water cooling pipe 38 inside the profiled housing 31, and the built-in water cooling pipe 38 is sealed and filled with coolant. The coolant sealed and filled in the built-in water cooling pipe 38 and the wind-guide channel 39 work together to perform heat exchange inside and outside the profiled housing 31.

Using a computational fluid dynamics simulation model, a design of the plurality of miniature air film holes 33 and the plurality of airflow conduits 372 is based on a known rotational speed of the monitoring device 30 to ensure smooth and uniform airflow. In this embodiment, the plurality of miniature air film holes 33 are circular or elliptical, and the plurality of airflow conduits 372 are straight or curved. In other embodiments, the plurality of miniature air film holes 33 and the plurality of airflow conduits 372 can be irregularly shaped to continually optimize the cooling effect.

The foregoing is only a preferred embodiment of the present disclosure and is not intended to limit the present disclosure, which may be subject to various changes and variations for those skilled in the art. Any modifications, equivalent substitutions, improvements, etc. made within the spirit and principles of the present disclosure shall be included in the scope of protection of the present disclosure.

What is claimed is:

1. A dynamic monitoring device for fatigue cracks of an aircraft engine on a test rig configured to use a testing method of a monitoring device and a test spindle forming asynchronous relative motion under simulated high-speed rotation, wherein:
the monitoring device comprises a profiled housing, as well as an eddy current testing sensor, a signal processing module, a wireless communication module, and a miniature centrifugal cooler that are encapsulated inside the profiled housing,
a detection end face of the profiled housing comprises a plurality of miniature air film holes,
at least one of an external side wall opposite to the detection end face or two external side walls adjacent to the detection end face of the profiled housing each comprises a wind-guide channel,
an air inlet and an air outlet of the wind-guide channel form a symmetrical double-horn-shaped structure,
an inner wall of the wind-guide channel is coated with a heat-dissipating coating,
the eddy current testing sensor is installed at a position inside of the profiled housing adjacent to the detection end face,
the eddy current testing sensor comprises a ferrite core and insulated wires,
the insulated wires are wound around an outside of the ferrite core,
the signal processing module and the wireless communication module are encapsulated on a rear end of the eddy current testing sensor and are electrically connected to the eddy current testing sensor,
the miniature centrifugal cooler comprises a coolant storage chamber and a plurality of airflow conduits connected to the coolant storage chamber,
first ends of the plurality of airflow conduits are respectively connected to the plurality of miniature air film holes corresponding to the plurality of airflow conduits, and
a junction between the plurality of airflow conduits and the coolant storage chamber is disposed with a centrifugal opening-and-closing valve that is automatically controlled by a centrifugal force.

2. The dynamic monitoring device for the fatigue cracks of the aircraft engine on the test rig according to claim 1, wherein:
the centrifugal opening-and-closing valve comprises a circular valve body, a rotating valve flap, and a sealing ring,
the rotating valve flap is installed on a middle of the circular valve body,
the sealing ring is embedded between the circular valve body and the junction, and
when the monitoring device rotates:
the rotating valve flap moves due to the centrifugal force to be opened, and
the coolant storage chamber is in communication with the plurality of airflow conduits.

3. The dynamic monitoring device for the fatigue cracks of the aircraft engine on the test rig according to claim 1, wherein:
the at least one of the external side wall opposite to the detection end face or the two external side walls adjacent to the detection end face of the profiled housing each comprises a built-in water cooling pipe inside the profiled housing, and
the built-in water cooling pipe is sealed and filled with coolant.

4. The dynamic monitoring device for the fatigue cracks of the aircraft engine on the test rig according to claim 1, wherein:
the plurality of miniature air film holes are circular or elliptical.

5. The dynamic monitoring device for the fatigue cracks of the aircraft engine on the test rig according to claim 1, wherein:
the plurality of airflow conduits are straight or curved.
